(19) United States
(12) Patent Application Publication
(10) Pub. No.: US 2004/0183980 A1
(43) Pub. Date: Sep. 23, 2004

(54) In-plane switching liquid crystal display and method for manufacturing the same

(76) Inventors: Cheuh-Ju Chen, Miao-Li (TW); Jia-Pang Pang, Miao-Li (TW); Tsau-Hua Hsieh, Miao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/805,472

(22) Filed: Mar. 19, 2004

(30) Foreign Application Priority Data
Mar. 19, 2003 (TW) 92106069

(51) Int. Cl. G02F 1/1343

(52) U.S. Cl. 349/141

(57) ABSTRACT

An IPS LCD includes a first substrate (21), a second substrate (22), and a liquid crystal layer (23) interposed between the first and second substrates. The first substrate includes in turn a first transparent sheet (211) and an alignment film (213). The second substrate includes in turn a second transparent sheet (221) and an insulating layer (224). A plurality of electrodes (222) and a thin film transistor (223) is formed between the second transparent sheet and the insulating layer. The alignment film has an alignment structure (214) thereon. The IPS LCD is low cost and low power consumption.

### BACKGROUND OF THE INVENTION

1. Field of the Invention

The present invention relates to a liquid crystal display and method for manufacturing the same, and particularly to an in-plane switching liquid crystal display (IPS LCD) and method for manufacturing the same.

2. The Prior Art

A typical IPS LCD includes two substrates opposite to each other, and a liquid crystal layer interposed therebetween. Liquid crystal molecules in the liquid crystal layer are twisted according to two alignment films, which are disposed on the two substrates respectively. In order to obtain a horizontal electric field parallel to the two substrates, a plurality of electrodes, which include pixel electrodes and common electrodes, are formed on a same substrate. When a voltage is applied across the two electrodes, the twisting direction and the birefringence characteristic of liquid crystal molecules in the liquid crystal layer are changed due to the horizontal electric field. Therefore, the liquid crystal display can display images. One important factor is an alignment direction of the liquid crystal molecules, which is controlled by the two alignment films and used to adjust the interaction between the substrates and the liquid crystal molecules.

An IPS LCD 1 is described in China Pat. Pub. No. 1,188,244A published on Jul. 22, 1998, as shown in FIG. 3. The IPS LCD 1 includes a first substrate 11, a second substrate 12, and a liquid crystal layer 13 including a plurality of liquid crystal molecules (not labeled) interposed therebetween.

The first substrate 11 includes in turn a first transparent sheet 111, a color filter layer 112, and a first alignment film 113 facing to the liquid crystal layer 13. The second substrate 12 includes in turn a second transparent sheet 121, an insulating layer 124, and a second alignment film 125 facing to the liquid crystal layer 13. A plurality of electrodes 122 and thin film transistors 123 are formed between the second transparent sheet 121 and the insulating layer 124.

The first and second alignment films 113 and 125 respectively have an anticipated alignment direction, and the first alignment film 113 is formed by an alignment treatment, for example, a rubbing process. The rubbing process includes the following main steps: coating alignment materials uniformly on one surface of the color filter layer 112, facing to the liquid crystal layer 13; curing the alignment materials; rubbing the cured alignment materials along an anticipated direction to form the alignment film 113. While the second alignment film 125 is not treated by the alignment treatment. Therefore, the first alignment film 113 has a stronger alignment force than the second alignment film 125.

When a voltage is applied across the electrodes 122, a horizontal electric field 14 is produced, which is parallel to the two substrates 11 and 12. An intensity of the horizontal electric field 14 is gradually decreased as a distance between the horizontal electric field 14 and the first substrate 11 decreased. The alignment force of the alignment films 113,125 is increased as a distance between the horizontal electric field 14 and the first substrate 11 decreased. Therefore, the liquid crystal molecules adjacent to the first substrate 11 are treated by a weak horizontal electric field intensity and a strong alignment force, while liquid crystal molecules adjacent to the second substrate 12 are treated by a strong horizontal electric field and a weak alignment force. As a result, the liquid crystal molecules adjacent to the first substrate 11 have smaller twisting angles than those adjacent to the second substrate 12, which lead to a poor transmission ratio of the IPS LCD 1. In order to eliminate the problem, a higher voltage is needed in the IPS LCD 1 to make the liquid crystal molecules twist at a same angle, which leads to a high power consumption.

Furthermore, the IPS LCD 1 needs the first alignment film 113 and the second alignment film 125 to align the liquid crystal molecules, which makes the structure and the manufacture of the IPS LCD 1 complex, so that the IPS LCD 1 is high cost.

An improved IPS LCD and method for manufacturing the same that overcomes the above-mentioned disadvantages is desired.

### SUMMARY OF THE INVENTION

An object of the present invention is to provide an IPS LCD which has low cost and low power consumption.

In order to achieve the object set forth, an IPS LCD in accordance with the present invention comprises a first substrate, a second substrate, and a liquid crystal layer interposed between the first and second substrates. The first substrate includes in turn a first transparent sheet and an alignment film. The second substrate includes in turn a second transparent sheet and an insulating layer. A plurality of electrodes and a thin film transistor formed between the second transparent sheet and the insulating layer. The alignment film has an alignment structure thereon. The IPS LCD is low cost, and which is low power consumption.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, cross-sectional view of one sub-pixel area of an IPS LCD according to the present invention;

FIG. 2 is a schematic, cross-sectional view taken along a line of II-II of FIG. 1, shown without an electric field thereat;

FIG. 3 is a schematic, cross-sectional view of one sub-pixel area of a conventional IPS LCD.

### DESCRIPTION OF THE PREFERRED EMBODIMENTS

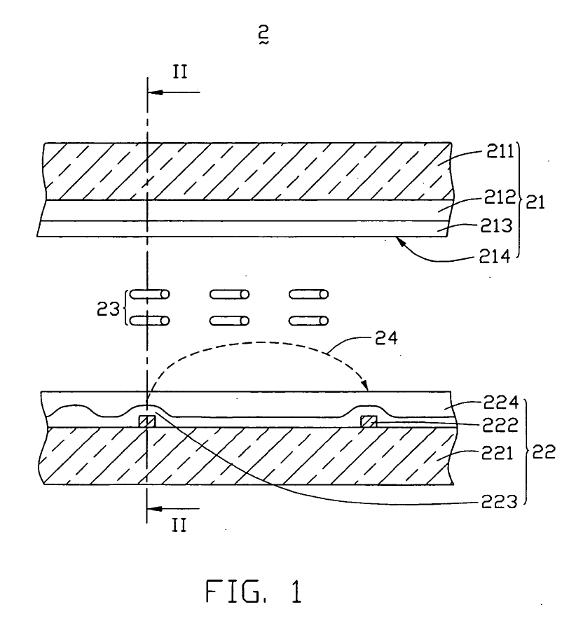

FIG. 1 is a schematic view of one sub-pixel area of an IPS LCD 2 according to the present invention. The IPS LCD 2 includes a first substrate 21, a second substrate 22, and a liquid crystal layer 23 having a plurality of liquid crystal molecules (not labeled) interposed therebetween.

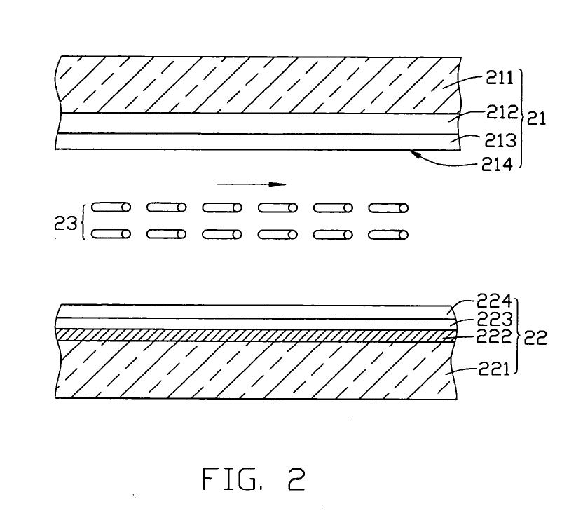

The first substrate 21 includes in turn a first transparent sheet 211, a color filter layer 212, and an alignment film 213 facing to the liquid crystal layer 23. An alignment structure 214 is provided on a surface of the alignment film 213, which faces the liquid crystal layer 23. The second substrate 22 includes in turn a second transparent sheet 221 and an insulating layer 224 facing to the liquid crystal layer 23. A plurality of electrodes 222 and thin film transistors 223 are formed between the second transparent sheet 221 and the insulating layer 224. Referring to the FIG. 2, the alignment structure 214 has an alignment direction (denoted by arrow). When no voltage is applied across the electrodes 222, the liquid crystal molecules are aligned along the alignment direction according to the lowest energy principle.

When a voltage is applied across the electrodes 222, a horizontal electric field 24 is produced, which is parallel to the first and the second substrates 21, 22. The horizontal electric field 24 has an inclination to the alignment direction, the best inclination is 90 degree.

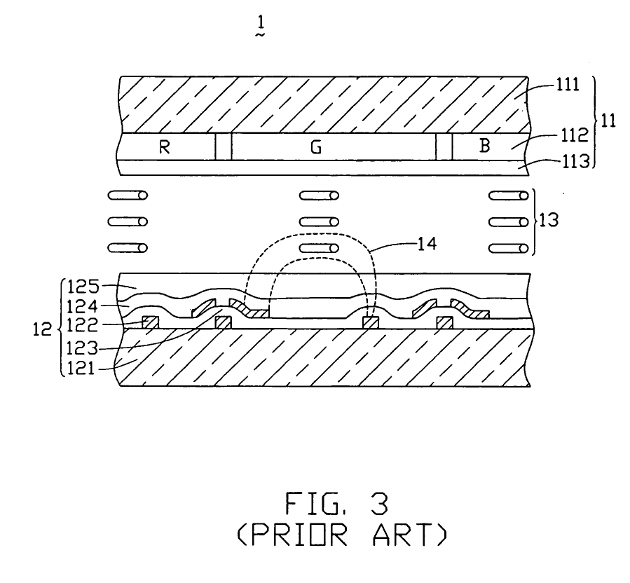

The IPS LCD 2 has a simple structure than the conventional IPS LCD 1 of FIG. 3 because only the alignment film 213 is used to align the liquid crystal molecules instead of two alignment films 113,125 in the IPS LCD 1, so that the IPS LCD 1 has low cost. In addition, in the IPS LCD 2, the alignment force of the liquid crystal molecules is smaller than that of the liquid crystal molecules in the IPS LCD 1 of FIG. 3, because only the alignment film 213 is used. As a result, the liquid crystal molecules are easy to twist in a smaller electric field, which is produced by a low voltage. In a word, the IPS LCD 2 is low cost and low power consumption because only the alignment film 213 is used.

A method for manufacturing the IPS LCD 2 includes the following main steps: providing the first transparent sheet 211 and the second transparent sheet 221, and attaching in turn the color filter layer 212 and the alignment film 213 on the first transparent sheet 211 to form the first substrate 21; forming the electrodes 222 and the thin film transistor 223 on the second transparent sheet 221; forming the insulating layer 224 on the electrodes 222 and the thin film transistor 223 to form the second substrate 22; assembling the first substrate 21 and the second substrate 22 to form a liquid crystal box; and injecting the liquid crystal molecules into the liquid crystal box to form the IPS LCD 2. The method for manufacturing the IPS LCD 2 elides a step of form another alignment film on the second substrate 22, so that the manufacture of the IPS LCD 2 is predigested. Furthermore, the cost of manufacture is down.

The alignment film 213 with the alignment structure 214 on the color filter layer 212 is performed by a rubbing process. In the rubbing process, a high-molecular film of polyimide is formed on the color filter layer 212 and rubbed with a cloth which is covered with a large number of fibers like velvet. As a result, the alignment film 213 with the alignment structure 214 is defined. The rubbing process is simple and inexpensive. Alternatively, the alignment structure 214 can be formed on the alignment film 213 by other processes, such as an ultraviolet alignment or a lithographic alignment, etc. The high-molecular film can be made of polyethylene, polystyrene, or the like.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An In-Plane Switching Liquid Crystal Display (IPS LCD), comprising:
a first substrate comprising in turn a first transparent sheet and an alignment film;
a second substrate comprising in turn a second transparent sheet and an insulating layer, a plurality of electrodes and a thin film transistor formed between the second transparent sheet and the insulating layer; and
a liquid crystal layer interposed between the first and the second substrates;
wherein the alignment film has an alignment structure thereon.

2. The IPS LCD of claim 1, wherein the first substrate further comprises a color filter layer formed between the first transparent sheet and the alignment film.

3. The IPS LCD of claim 1, wherein the alignment film is made of polyimide.

4. The IPS LCD of claim 1, wherein the alignment film is made of polyethylene.

5. The IPS LCD of claim 1, wherein the alignment film is made of polystyrene.

6. A method for manufacturing an In-Plane Switching Liquid Crystal Display (IPS LCD), comprising the steps of:
providing a first transparent sheet and a second transparent sheet facing to each other;
attaching in turn a color filter layer and an alignment film with an alignment structure on the first transparent sheet to form a first substrate;
forming a plurality of electrodes and a thin film transistor on the second transparent sheet;
attaching an insulating layer on the electrodes and the thin film transistor to form a second substrate;
assembling the first substrate and the second substrate to form a liquid crystal box;
injecting liquid crystal molecules into the liquid crystal box to form the IPS LCD.

7. The method of claim 6, wherein the alignment structure is formed on the alignment film by a rubbing process.

8. The method of claim 6, wherein the alignment film with the alignment structure is formed by an ultraviolet alignment.

9. The method of claim 6, wherein the alignment film with the alignment structure is formed by a lithographic alignment.

10. A method of manufacturing an In-Plane Switching Liquid Crystal Display (IPS LCD), comprising the steps of:
providing a first transparent sheet and a second transparent sheet facing to each other;
attaching a color filter layer on the first transparent sheet to form a first substrate;
forming a plurality of electrodes and a thin film transistor on the second transparent sheet;
attaching an insulating layer on the electrodes and the thin film transistor to form a second substrate;
assembling the first substrate and the second substrate to form a liquid crystal box; and
injecting liquid crystal molecules into the liquid crystal box to form the IPS LCD; wherein
one alignment file is applied upon only one of said first substrate and said second substrate, facing to said crystal molecules.
